(19) United States
(12) Patent Application Publication
(10) Pub. No.: US 2009/0196142 A1
(43) Pub. Date: Aug. 6, 2009

(54) INFORMATION RECORDING MEDIUM, INFORMATION RECORDING METHOD, AND INFORMATION RECORDING AND REPRODUCING APPARATUS

(75) Inventors: Keiichiro YUSU, Yokohama-shi (JP); Masahiro SAITO, Yokohama-shi (JP); Kazuto KURODA, Yokohama-shi (JP); Takashi USUI, Yokohama-shi (JP); Kazuo WATABE, Yokohama-shi (JP); Chosaku NODA, Yokohama-shi (JP); Nobuaki KAJI, Yokohama-shi (JP); Tsukasa NAKAI, Hino-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/362,395

(22) Filed: Jan. 29, 2009

(30) Foreign Application Priority Data
Jan. 31, 2008 (JP) 2008-020950

(51) Int. Cl. G11B 7/00

(52) U.S. Cl. 369/100; 369/275.1; G9B/7

(57) ABSTRACT

According to one embodiment, in an information recording medium for which a phase change material is used and in which information is recorded on, reproduced from, and erased from a recording layer by light irradiation, a recrystallization width WR at a periphery of an amorphous recording mark formed on the recording layer by light irradiation, and a recording mark width WA and a track pitch TP satisfy 1.0<WR/WA<1.1 and 2/3<WA/TP<4/3.

### CROSS-REFERENCE TO RELATED APPLICATIONS

This application is based upon and claims the benefit of priority from Japanese Patent Application No. 2008-020950, filed Jan. 31, 2008, the entire contents of which are incorporated herein by reference.

### BACKGROUND

1. Field

One embodiment of the present invention relates to an information recording medium with a large capacity and a long shell life, a recording method for the information recording medium, and an information recording and reproducing apparatus.

2. Description of the Related Art

In a rewritable information recording medium using a phase change recording material and typified by DVD-RAM, DVD-RW, and the like, recording, erasure, and reproduction are performed by leaser beams provided by a light source of a particular wavelength. When a previously initially crystallized phase change medium is irradiated with a recording beam made up of multiple pulses, the irradiated part is made amorphous and formed into a recording mark. The irradiated part offers a lower reflectance than the crystallized part. The recording mark can be erased by being irradiated with continuous light for recrystallization. Normally, the recording and the erasure are simultaneously performed, and this is called overwrite. Such a difference in reflectance between the recorded part and the unrecorded part is utilized to reproduce information.

DVD-RAM allows information to be recorded along spiral grooves and lands each sandwiched between the grooves. In DVD-RAM with a single-side capacity of 4.7 GB, the interval between the land and the groove is 0.615 μm. In HD DVD-RAM, which is a next-generation DVD, the interval is reduced to as short as 0.34 μm. With HD DVD-RAM, cross erase has started to come to an issue; in the cross erase phenomenon, information recorded in the land (groove) is partly erased when recording is performed on the adjacent groove (land). This phenomenon is unavoidable even with DVD-RW, in which information is recorded only in the grooves, and is nonnegligible even with HD DVD-RW with a groove interval of 0.4 μm.

A technique disclosed in Jpn. Pat. Appln. KOKAI Publication No. 11-53773 is intended to reduce the possible cross erase phenomenon and possible crosstalk during high-density recording. The technique specifies, for the recording medium, the relationship between the width W1 of a mark in an amorphous phase and the beam width W2 of recording laser light (W1/W2≦0.65). The technique also specifies the relationship between the width W3 of a melted area and the mark width W1 (W1/W3≦0.85). However, the technique still has a problem to be solved; a recording layer according to the technique is what is called a quasi-two-dimensional GeSbTe alloy, thus preventing high-speed recording.

In the cross erase phenomenon, when information is recorded in a track adjacent to a recorded track, the recording mark on the recorded track is partly erased. The phenomenon is caused by a beam diameter that is large compared to a track width and an associated intra-film temperature distribution. When the edge of a beam recording the adjacent track passes over an end of an already present recording mark, the temperature of the end of the already present recording mark becomes equal to or higher than a crystallization temperature. The end is thus crystallized to cause the cross erase phenomenon. In this case, when the end of the recording mark is cooled after the crystallization temperature has been exceeded, the cross erase occurs only if the end is maintained at least the crystallization temperature for a time sufficient to cause crystallization. Furthermore, the recording mark end is often crystallized after the temperature of the end has been raised to the melting point or higher. The mechanism of the cross erase in this case is similar to that described above; when the recording mark end is cooled after the melting point has been exceeded, the cross erase occurs if the recording mark end is maintained at least the crystallization temperature for a time sufficient to cause crystallization.

The above-described cross erase phenomenon depends significantly on the physical properties of the phase change material used. An SbTe-containing eutectic material, which enables high-speed overwriting, is mostly used for DVD-RW and expected to offer a very high crystal growth speed when the melted SbTe-containing eutectic material is cooled. Thus, crystallization is facilitated even under a high linear speed condition under which the beam passes very quickly over the recording mark during cooling. However, during recording, the high-speed crystallization makes the formation of the amorphous recording mark difficult. That is, a laser with a Gaussian intensity distribution increases the temperature of the irradiated part of the phase change material according to a temperature distribution in which the temperature varies concentrically around a beam center. During cooling, a part of the material which exceeds at least the melting point is made amorphous. However, for the high-speed-crystallization material, a slowly cooled part is partly recrystallized.

With laser beam irradiation, a portion of the irradiated part which is closer to the center, which is hotter, is cooled at higher speed, whereas a portion of the irradiated part which is closer to the periphery is cooled at a lower speed. Thus, only a central part of the material is made amorphous. That is, when the high-speed-crystallization material is used to form an amorphous recording mark, the peripheral part of the recording mark may be recrystallized in spite of melting. The recrystallized part at the periphery of the recording mark is called a recrystallization ring. That is, to allow formation of a recording mark with a width equivalent to the track width, the temperature of an area with a width larger than the track width needs to be increased to the melting point or higher so that the area is melted. If the melted area spreads to the adjacent track, the recording mark on the already recorded adjacent track may partly be recrystallized to corrupt information. Even with the eutectic phase change material, which can be easily crystallized even at high linear speed, forming an amorphous mark without causing the cross erase is more difficult in the next generation or next generation involving a further reduced track pitch.

Thus, an object of the present invention is to provide an information recording medium, an information recording method, and an information recording and reproducing apparatus which enable high-speed recording and erasure without causing the cross erase.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram schematically showing the relationship between a recording mark and a track in an information recording medium according to an embodiment;

FIG. 2 is a sectional view showing a part of the information recording medium according to the embodiment;

FIG. 3 is a sectional view showing a part of the information recording medium according to the embodiment;

FIG. 4 is a diagram showing a recording strategy used for recording and erasure in the information recording medium according to the embodiment;

FIG. 5 is a diagram showing the relationship PRSNR and a pulse width TW varied during recoding on the information recording medium according to the embodiment;

FIG. 6 is a diagram showing the relationship between PRSNR and the pulse width TW varied with linear speed during recording on the information recording medium according to the embodiment;

FIG. 7 is a diagram schematically showing an example of the configuration of an optical recording apparatus according to the embodiment;

FIG. 8 is a diagram showing an example of a semiconductor laser used as a light source for the optical recording apparatus according to the embodiment;

FIG. 9A is a diagram showing an example of the waveform of a drive current for the semiconductor laser for normal recording;

FIG. 9B is a diagram showing an example of the waveform of exit light from the semiconductor laser for normal recording;

FIG. 10A is a diagram showing an example of the waveform of a drive current for the semiconductor laser for generation of a relaxation oscillation pulse;

FIG. 10B is a diagram showing an example of the waveform of exit light from the semiconductor laser for generation of the relaxation oscillation pulse;

FIG. 11 is a diagram showing an example of measurements of the relaxation oscillation waveform from a semiconductor laser of resonator length 650 μm;

FIG. 12A is diagram illustrating an amorphous mark formed by a conventional recording pulse;

FIG. 12B is a diagram illustrating an amorphous mark formed by a short pulse;

FIG. 13 is a diagram illustrating an example of the distribution of the temperature on a recording track for short pulse recording;

FIG. 14 is a diagram illustrating an example of the distribution of the temperature on a recording track for conventional pulse recording; and

FIG. 15 is a diagram showing an example of an optical pulse waveform observed when the drive pulse for the semiconductor laser is adjusted so as to generate a relaxation oscillation pulse three times.

### DETAILED DESCRIPTION

Various embodiments according to the invention will be described hereinafter with reference to the accompanying drawings. In general, according to one embodiment of the invention, an information recording medium for which a phase change material is used and in which information is recorded on, reproduced from, and erased from a recording layer by light irradiation, wherein a recrystallization width WR at a periphery of an amorphous recording mark formed on the recording layer by light irradiation, and a recording mark width WA and a track pitch TP satisfy 1.0<WR/WA<1.1 and 2/3<WA/TP<4/3.

An embodiment of the present invention will be described below with reference to the drawings. First, a basic concept will be described.

The information recording medium is composed of a recording layer made up of a phase change material, an optical interference layer made up of a dielectric, and a reflection layer made up of metal. An SbTe—, InSb—, or GaSb-containing compound that is an eutectic compound with a high crystal growth speed is suitable as the recording layer. Optical contrast and recording characteristics can further be improved by adding an appropriate amount of Ge, IN, Co, Ag, or the like to the eutectic compound. The optical interference layer is used to increase the magnitude of a change in reflectance after recording and to mechanically and thermally protect the recoding layer. A composite compound made up of any of ZnS, SiO2, AL2O3, Si3N4, ZrO2, AlN, Cr2O3, GeN, Ta205, and Nb205 is suitable as the optical interference layer. The optical interference layer is not only intended for optical enhancement but also serves to reduce possible stress imposed on the recording layer and to control a temperature increase caused by laser irradiation. To achieve these objects, the optical interference layer may be composed of at least two layers. The reflection layer is mainly composed of Al, Ag, or Au and provided to obtain reflection light for reproduction and to control the temperature during beam irradiation for recording.

Now, a recording method will be described. A short pulse of pulse width at least 200 ps and at most 1 ns is used for recording on the information recording medium.

Such a short pulse is made of a 1st-order component of relaxation oscillation of a semiconductor laser (LD), and has a peak output of several tens of mW.

For example, to record a mark of minimum mark length 0.19 μm, which conforms to HD DVD-RAM specifications, pulse light of output about 5 to 10 mW and pulse width about 10 ns is applied to form the mark. However, if an attempt is made to use this method for recording on the above-described high-speed-crystallization material, a recrystallization ring may be formed in a peripheral part of the mark after melting. As a result, a recording mark on an adjacent track may be erased.

In contrast, the embodiment enables a mark with a reduced recrystallization ring to be formed by applying a short pulse of peak pulse several tens of mW and pulse width at least 200 ps and at most 1 ns. With a high-speed-crystallization material used in the present invention, a phenomenon is observed in which crystallization occurs when the material is held in a temperature region of at least a crystallization temperature and at most a melting point for several tens of ns.

In particular, with the SbTe-containing eutectic compound, crystallization progresses at high speed during a cooling process after melting. Thus, crystallization progresses even when the compound is held at a temperature equal to or higher than the crystallization temperature and equal to or lower than the melting point for only a short time (several tens of ns). Thus, even for high-speed overwriting, which enables high-speed data transfer, an amorphous part can be easily set to an erase state (crystallized state).

However, this characteristic works against recording. A part of the material irradiated with a pulse-like recording beam is concentrically melted. A central part of the material, which is cooled at higher speed, is made amorphous. On the other hand, the periphery of the amorphous part is melted but crystallized owing to a lower cooling speed. Thus, when an amorphous mark of a desired size is formed, a donut-shaped recrystallization ring is formed at the periphery of the mark owing to the melting and recrystallization.

An attempt to form an amorphous mark over the entire width of a track (groove or land) which is a guide groove results in the above-described recrystallization ring sticking out to an adjacent track. This means that an amorphous mark already recorded on the adjacent track is partly melted and recrystallized. This in turn leads to corruption of recorded information, which is a serious problem.

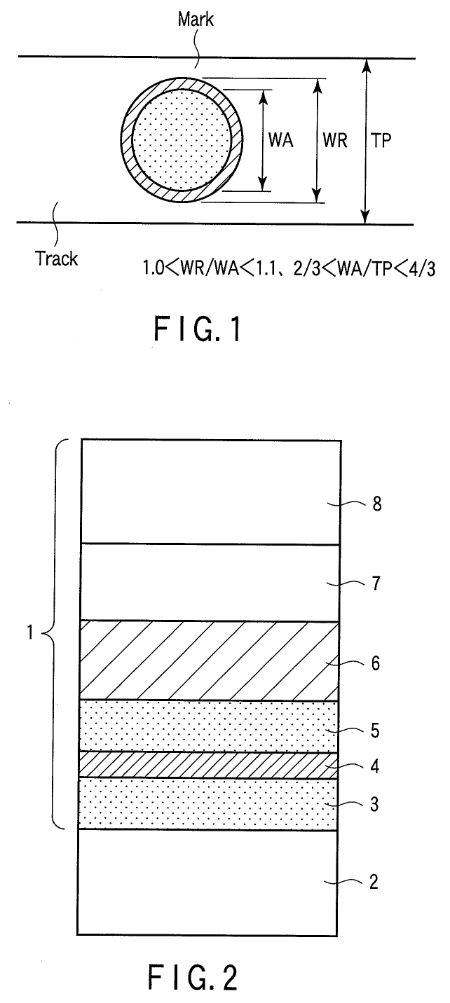

To avoid such a problem, recording can be effectively performed using a combination of the high-speed-crystallization material according to the present invention and a short pulse of at least 200 ps and at most 1 ns. This method allows the recrystallization width WR at the periphery of the amorphous mark with respect to the recording mark width WA in a radial direction to satisfy the relationship 1.0<WR/WA<1.1. This in tune enables overwriting without affecting the recording mark on the adjacent track. When temperature simulation is performed under the condition that the amorphous mark is formed over the entire track width, the temperature of the adjacent track is almost prevented from exceeding the melting point regardless of a linear speed. This indicates the possibility of ideal recording with no recrystallization ring formed in the peripheral part of the mark. In this case, a high-quality recording state can be established when 1.0<WR/WA<1.1 and 2/3<WA/TP<4/3. TP denotes the track width. FIG. 1 schematically shows the relationship between a recording mark and a track when the above-described conditions are satisfied.

As described above, the combination of the phase change material according to the embodiment and short pulse recording enables high-density recording with the reduced possibility of cross erase. The embodiment is particularly effective for increasing the density in the radial direction of a disc.

FIG. 2 is a sectional view showing a part of an information recording medium according to the embodiment produced on a substrate. An information recording medium 1 according to the embodiment is formed on a substrate 2 made of resin, glass, or the like. The information recording medium 1 has an optical interference layer 3, a phase change recording layer 4, an optical interference layer 5 and a reflection layer 6. Moreover, a substrate 8 is stuck to the reflection layer 6 via an ultraviolet hardening resin layer 7. In this case, the thicknesses of the substrates 2 and 8 may be selected according to an objective lens NA in a reproducing apparatus. For example, both substrates desirably have a thickness of about 0.6 mm when a recording and reproducing apparatus has a light source wavelength of 405 nm and an objective lens NA is 0.65. Alternatively, the substrates 2 and 8 desirably have thicknesses of about 0.1 mm and about 1.1 mm, respectively, when the light source wavelength and the objective lens NA are 405 nm and 0.85, respectively. Thus, an optical disc according to the present invention can exert effects regardless of the optical system of the recording and reproducing apparatus.

### EXAMPLES

Specific examples will be illustrated below to describe the embodiment in further detail.

### Example 1

A PC substrate 10 of diameter 120 mm and thickness 0.6 mm with lands and grooves of track pitch 0.30 μm formed thereon was vacuumed to about 6.0×10−4 Pa in a magnetron sputter apparatus. The following layers were then formed. ZnS (80 mol %)-SiO2 (20 mol %) was deposited to a thickness of 50 nm by RF magnetron sputtering to form an optical interference layer 11. Sb (70 at %) Te (30 at %) was deposited to a thickness of 10 nm by RF magnetron sputtering to form a recording layer 12. ZnS (80 mol %)-SiO2 (20 mol %) was deposited to a thickness of 20 nm by RF magnetron sputtering to form an optical interference layer 13. Ag98Pd1Cu1 was deposited to a thickness of 100 nm by a DC magnetron sputter method to form a reflection layer 14.

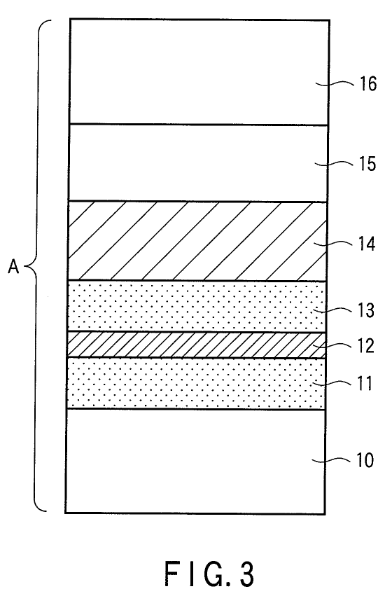

Subsequently, an ultraviolet hardening resin 15 was spin coated, and a PC substrate 16 was stuck to the ultraviolet hardening resin 15 to produce a disc A according to the present example (the disc A is shown in FIG. 3). The disc A corresponds to a storage capacity of 25 GB.

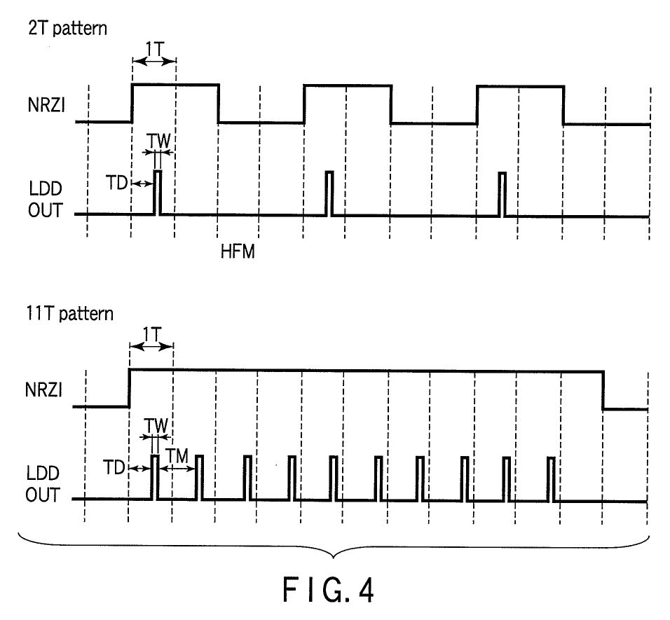

The disc A was initially crystallized by a semiconductor laser of wavelength 650 nm. The disc A was then evaluated for recording and reproduction under conditions shown in Table 1. Table 1 is shown in the latter half of the specification. FIG. 4 shows a recording strategy used for recording and erasure. To record a 2T mark, which is the shortest mark, a pulse with a pulse width TW was generated later than the head of a standard clock by TD=0.5T (T=9 ns) as shown in an upper part of FIG. 4. T denotes the shortest mark, which corresponds to a length of 2 bits. NRZI denotes a waveform corresponding to a recording signal. LDD denotes an optical output from the semiconductor laser.

On the other hand, to record an nT mark (n is an integer, 3≦n≦11), a pulse with a pulse width TW was generated later than the head by TD=0.5T, n-1 times at intervals of 1T as shown in a lower part of FIG. 4. This recording strategy was used to randomly generate nT to record a random pattern. Then, during reproduction, PRSNR (Partial Response Signal to Noise Ratio), which is an evaluation index, was measured. If any groove (land) is measured, then first, recording is performed on the groove (land), and then, recording is sequentially performed on two grooves (lands) each located adjacent to a land (groove) located adjacent to the above-described groove (land). Subsequently, recording is sequentially performed on the two adjacent lands (grooves). This operation was repeated 10 times. Recording was thus performed on the five consecutive tracks, and a signal was then reproduced from an appropriate one of the grooves (lands). This is what is called 5 track recording and reproduction.

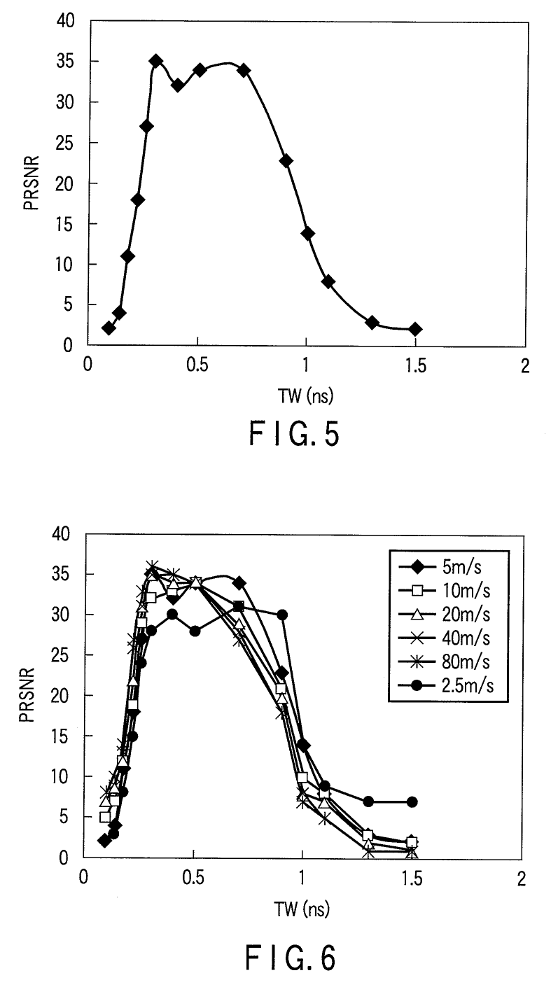

FIG. 5 shows PRSNR observed when the pulse width TW was varied during recording in Example 1. FIG. 5 shows that PRSNR is smaller than 15 when the pulse width TW is less than 0.2 ns and at least 1.0 ns, clearly indicating that the corresponding standard value for HD DVD is not satisfied. In contrast, FIG. 5 shows that the best characteristics are exhibited when the pulse width TW is at least 0.2 ns and less than 1.0 ns.

In this case, the recording mark was observed with a transmissive electron microscope when TW=0.1 ns, 0.15 ns, 0.25 ns, 0.5 ns, and 1.5 ns. Table 2 shows the recrystallization widths and amorphous mark widths of 2T and 11T marks formed under the respective conditions, and WR/WA and WA/TP. With the 2T mark, at a pulse width of 0.1 ns, the recrystallization width WR is the same as the mark width WA and WR/WA=1, but WA/TP=0.6. This indicates that the recording mark width is significantly small compared to a track pitch. Thus, the reproduction signal is expected to have been reduced to decrease PRSNR to a value equal to or smaller than 15. With TW=1.5 ns, WR/WA=1.25, indicating a large recrystallization width. Thus, the recording mark on the adjacent track is expected to have been erased to reduce PRSNR. Moreover, the 2T mark also tends to be reduced compared to TW=1.0 ns. The 11T mark also exhibits a similar variation tendency with respect TW.

The above-described results clearly indicate that very good characteristics can be obtained by using, for recording, the information recording method of providing irradiation with a short pulse of peak output several tens of mW and pulse width at least 200 ps and at most 1 ns according to the embodiment.

Comparative Example 1

The same disc A as that used in Example 1 was used to examine linear speed dependence during recording. Recording was performed at 2.5 m/s, 5.0 m/s, 10 m/s, 20 m/s, 40 m/s, and 80 m/s corresponding to speeds 0.5 times (0.5×), twice (2×), 4 times (4×), 8 times (8×), and 16 times (16×) faster than a reference linear speed of 5.0 m/s, respectively. At this time, to maintain recording density constant, recording frequency was varied to maintain the minimum pit length constant. For example, by, for the 1× speed, performing recording at 14 MHz, and for the 2× speed, changing the recording frequency to perform recording at 28 MHz, the minimum pit length can be maintained constant at 0.177 μm. At any linear speed, PRSNR during reproduction was measured with the pulse width TW varied between 0.1 ns and 1.5 ns. The recoding and reproducing conditions other than the linear speed are similar to those in Example 1. At all the linear speeds, PRSNR exhibited a value equal to or greater than the standard value of 15 at a pulse width of at least 0.2 ns and less than 1.0 ns. This clearly indicates that very good characteristics are obtained with a large linear speed margin by recording on the information recording medium according to the embodiment using the information recording method according to the embodiment. FIG. 6 shows measurements of signals recorded at the respective linear speeds.

### Example 2

A disc B was produced which had the same layer configuration as that in Example 1 except that the recording layer in Example 2 was composed of Ga11Sb88Col. The disc B was evaluated as is the case with Example 1. As a result, the disc B exhibited a PRSNR value equal to or greater than 15 in the region of a pulse width of at least 0.2 ns and less than 1.0 ns. This clearly indicates that very good characteristics are obtained by means of recording on the information recording medium according to the present invention using the information recording method according to the present invention.

Recording and Reproducing Apparatus

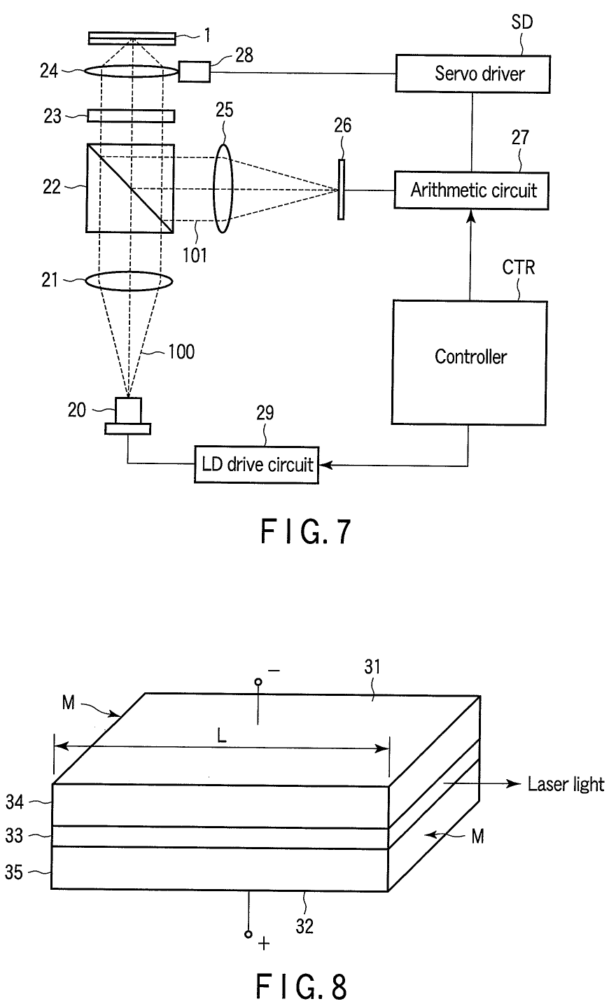

Now, a recording and reproducing apparatus performing the above-described recording and reproduction will be described. As shown in FIG. 7, the recording and reproducing apparatus according to the present embodiment uses a semiconductor laser 20 with a short wavelength as a light source. Light exiting the semiconductor laser has a wavelength belonging to, for example, a violet wavelength band between 400 nm and 410 nm.

Exit light 100 from the semiconductor laser light source 20 is changed into parallel light by a collimate lens 21. The parallel light then passes through a polarized light beam splitter 22 and a λ/4 plate 23. The light then enters an objective lens 24. Thereafter, the light passes through a substrate in an optical disc 1 and is focused on a target information recording layer. Reflected light 101 from the information recording layer in the optical disc 1 passes through a layer 2 in the optical disc 1 and then through the objective lens 24 and the λ/4 plate 23. The light is then reflected by the polarized beam splitter 22 and then passes though a focusing lens 25 and enters a photodetector 26.

A light receiving section of the photodetector 26 is normally divided into a plurality of smaller light receiving sections each of which outputs a current corresponding to light intensity. The output currents are converted into voltages by an I/V amplifier (not shown in the drawings). An arithmetic module 27 then arithmetically processes the voltages into an HF signal for reproducing user data information and a focus error signal and a track error signal for controlling the position of a beam spot provided by the light source. The arithmetic module 27 is controlled by a controller CTR.

The objective lens 24 can be driven in a vertical direction and a disc radial direction by an actuator 28. The objective lens 24 is controlled by a servo driver SD so as to follow an information track on the optical disc 1. The optical disc 1 is a recordable disc to which information can be written; information is written to the optical disc 1 by the exit light 100 from the semiconductor laser 20. The quantity of the exit light 100 from the semiconductor laser 20 can be controlled by a semiconductor laser drive module 29. To record information on the optical disc 1, the semiconductor laser 20 is controlled so as to emit a relaxation oscillation pulse. The semiconductor laser drive module 29 is controlled by the controller CTR. A recording pulse used to record information on the optical disc 1 will be described below in detail.

The optical disc 1 comprises two discs in which the information recording layer including the recording film according to the present invention is formed and which are stuck to at least one of the substrates in opposite directions. The substrate has a thickness of, for example, 0.6 mm. The entire optical disc 1 has a thickness of about 1.2 mm.

The present embodiment illustrates the optical disc having the information recording layer made up of the four layers. However, the present invention is also applicable to an optical disc having an information recording layer with at least five layers including, for example, interface layers provided over and under the recording layer. Furthermore, the present embodiment illustrates the single information recording layer. However, the present invention is also applicable to an optical disc having at least two information recording layers. Moreover, the present embodiment uses the optical disc as a recording medium. However, the embodiment is also applicable to a card-like recording medium.

FIG. 8 shows an example of the semiconductor laser 20 used as a light source for an optical recording apparatus according to the embodiment. FIG. 8 shows only a semiconductor chip portion serving as a light emission member of the semiconductor laser. The chip portion is normally fixed to a metal block serving as a heat sink and composed of a base material, a cap with a glass window, and the like.

Here, only the semiconductor chip portion, which is related directly to laser light emission, will be described. The semiconductor laser chip is a very small block having, by way of example, a thickness (the vertical direction of the plane in the figure) of about 0.15 mm, a length (L in the figure) of about 0.5 mm, and a width (the depth direction in the figure) of about 0.2 mm. An upper end 31 and a lower end 32 of the laser chip are each an electrode. The upper end 31 is a minus electrode, and the lower end 32 is a plus electrode.

A central active layer 33 emits laser light. An upper clad layer 34 and a lower clad layer 35 are formed over and under the active layer 33, respectively. The upper clad layer 34 is an n-type clad layer in which a large number of electrons are present. The lower clad layer 35 is a p-type clad layer in which a large number of holes are present.

When a forward voltage is applied between the electrodes 32 and 31, from the electrode 32 to the electrode 31, that is, current is passed from the electrode 32 toward the electrode 31, a large number of holes and electrodes excited in the active layer 33 are recoupled to one another. Light is thus emitted which corresponds to energy lost in this case. A material for the upper clad layer 34 and the lower clad layer 35 is selected such that the refractive index of the upper clad layer 34 and the lower clad layer 35 is lower than that of the active layer (for example, by 5%). Light generated in the active layer 33 is reflected at the boundary between the active layer 33 and each of the upper and lower clad layers 34 and 45 to become a light wave traveling in the lateral direction of the figure.

End surfaces of the active layer 33 shown in the right and left of FIG. 8 constitute mirror surfaces M. Thus, the active layer 33 independently forms an optical resonator. The light wave travels through the active layer 33 in the lateral direction and is reflected by the mirror surfaces at the laterally opposite ends of the active layer 33. The light is then amplified in the active layer 33 and finally emitted from the right end (and the left end) in the figure as laser light. In this case, the resonator length of the semiconductor laser 20 refers to a length L in the lateral direction of the figure.

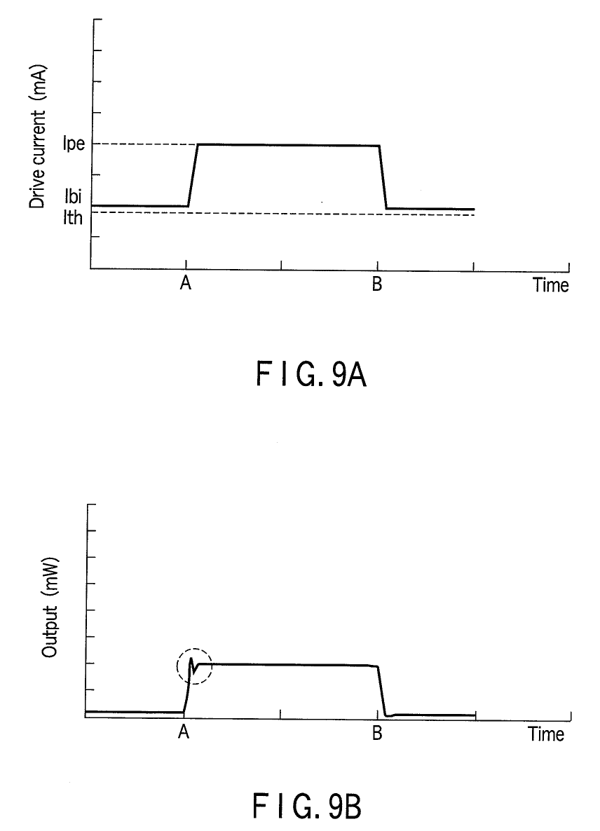

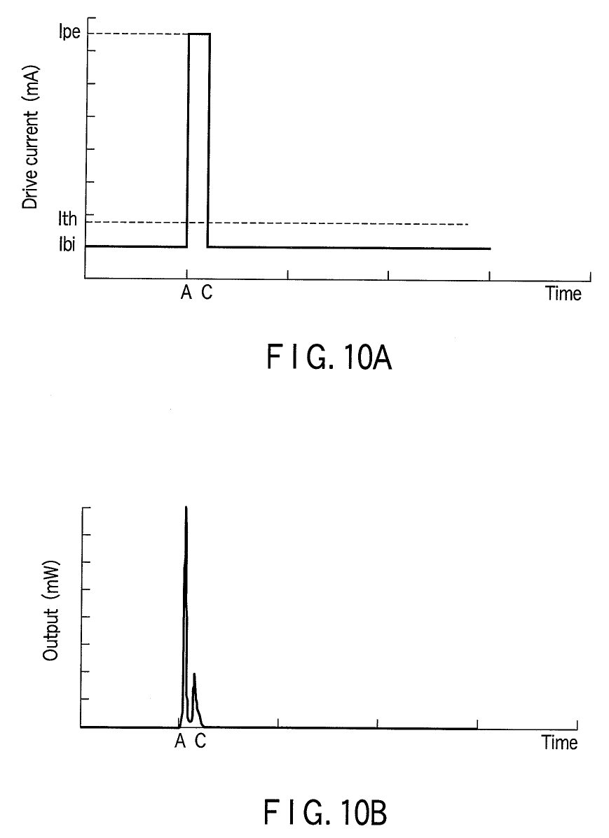

The waveform of exit light from the semiconductor laser 20 is controlled by a drive current generated by the semiconductor laser (LD: Laser Diode) drive module 29. How a recording pulse used for recording on the optical disc 1 is generated by the drive pulse from the LD drive module 29 will be described with reference to FIGS. 9A, 9B, 10A, and 10B.

FIGS. 9A and 9B show a normal LD drive current and a normal LD exit waveform. FIGS. 10A and 10B show an LD drive current and an LD exit waveform observed when a relaxation oscillation pulse is generated. The drive current is controlled between two levels, that is, a bias current Ibi and a peak current Ipe shown in FIGS. 9A and 9B, respectively. The bias current may further be divided into two or three levels for control. However, for simplification, in the description below, each of the bias current Ibi and the peak current Ipe has one level.

For normal recording pulse generation, as shown in FIG. 9A, the LD drive module 29 first generates the bias current Ibi set to a level slightly higher than a threshold current Ith at which the semiconductor laser 20 starts laser oscillation. The LD drive module 29 thus drives the semiconductor laser 20. Subsequently, at time A, the peak current Ipe is applied to obtain desired peak power. After being applied for a given time, the peak current Ipe is reduced to the bias current Ibi again at time B. FIG. 9B shows a temporal variation in the intensity of exit light from the semiconductor laser 20 in this case.

As shown in FIG. 9B, the exit light intensity indicates power that is so low that no data can be recorded on the optical disc 1, until time A, that is, while the semiconductor laser 20 is driven by the bias current Ibi. This level is maintained until the peak current Ipe is applied, the intensity is reduced to recoding power, and the drive current is reduced to the bias current Ibi level at time B. After time B, the exit light intensity indicates low power again. In this manner, the semiconductor laser 20 is controlled so as to exit the recording pulse during the period between the times A and B.

More detailed observation of the exit light intensity shows that when increased to the recording power at time A, the intensity increased and decreased instantaneously before stabilizing to the steady-state recording power (a part of FIG. 9B pointed by an arrow (a dashed part of FIG. 9B)). This is due to relaxation oscillation of the semiconductor laser 20. For the normal recording pulse generation, control is performed so as to minimize the relaxation oscillation.

The relaxation oscillation is a transient oscillation phenomenon that occurs in the semiconductor laser when the drive current increases rapidly from a certain level to a given level substantially exceeding a threshold voltage. The magnitude of the relaxation oscillation decreases for every oscillation. The vibration is eventually stopped.

The optical recording apparatus according to the embodiment positively utilizes the relaxation oscillation for recording. If the relaxation oscillation is used as a recording pulse, then as shown in FIG. 10A, the LD drive module 29 first generates the bias current Ibi set to a level lower than the threshold current Ith for the semiconductor laser 20. The LD drive module 29 thus drives the semiconductor laser 20.

Thereafter, at time A, the drive current is rapidly increased to the peak current level IPe in a rise time that is shorter than that for the normal recording pulse generation. Then, a certain time later which is shorter than that for the normal recording pulse generation, the drive current is increased to the bias current Ibi again at time C. FIG. 10B shows a temporal variation in the intensity of exit light from the semiconductor laser 20 in this case.

As shown in FIG. 10B, the semiconductor laser 20 does not start laser oscillation until time A, that is, while the semiconductor laser 20 is driven by the bias current Ibi, which is lower than the threshold voltage Ith. The semiconductor laser 20 thus emits light at a negligible level as a light emission diode. Subsequently, at time A, the rapid current application starts the relaxation oscillation to rapidly increase the exit light intensity. Subsequently, the light resulting from the relaxation oscillation continuously exits the semiconductor laser 20 until time C, when the applied current is returned to a value equal to or lower than the threshold current again. In this example, the timing when a pulse resulting from the second period of the relaxation oscillation is generated corresponds to time C, when the recording pulse generation is completed.

Thus, the pulse resulting from the relaxation oscillation is characterized in that the exit light intensity increases in a very short time and decreases at a given period determined by the structure of the semiconductor laser. Consequently, by using the pulse resulting from the relaxation oscillation as a recording pulse, a short pulse can be obtained which has a short rise time and a short fall time which are not offered by the normal recording pulse and which also has a high peak intensity.

The resonator length L of LD and a relaxation oscillation period T have the following relationship, which is commonly known.

T=k·{2 nL/c} (1)

In this formula, k denotes a constant, n denotes the refractive index of the semiconductor laser, and c denotes a light speed (3.0×108 (m/s)). Therefore, the LD resonator length L and the relaxation oscillation period T or the relaxation oscillation pulse width are in a proportional relationship.

Thus, the LD resonator length L may be increased in order to increase the relaxation oscillation pulse width and reduced to reduce the relaxation oscillation pulse width. That is, the relaxation oscillation pulse width can be controlled by the LD resonator length L.

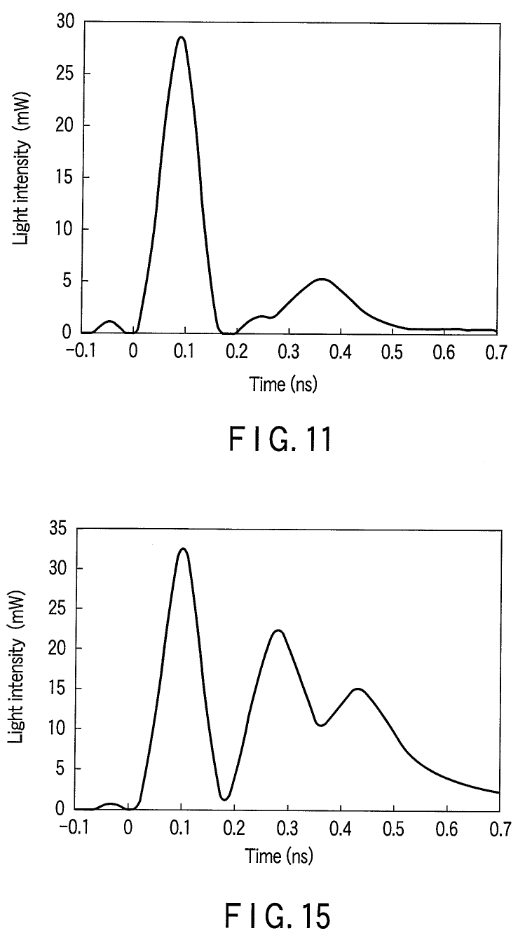

FIG. 11 shows measurements of the relaxation oscillation waveform from a semiconductor laser of resonator length L 650 μm. FIG. 11 shows that the relaxation oscillation pulse width is about 81 ps in connection with full width at half maximum. Since Formula (1), described above, indicates that the resonator length L of LD and the relaxation oscillation pulse width are in the proportional relationship, the following relationship is established as a conversion formula for the resonator length L of the semiconductor laser and the relaxation oscillation pulse width obtained (FWHM) Wr.

Wr(ps)=L(μm)/8.0(μm/ps) (2)

Now, description will be give of recording of data on the optical recording medium performed by the optical recording apparatus according to the present embodiment. The optical disc 1 is, for example, a rewritable disc such as DVD-RAM, DVD-RW, HD DVD-RW, or HD DVD-RAM. The phase change material according to the present invention is used for the recording layer in the optical disc 1. Data bits are recorded on and erased from the phase changing optical disc by controlling the intensity of pulse-like laser light focused on the recording layer.

Recording means that an amorphous mark is formed in an area of the recording layer initialized to a crystallized state. The amorphous mark is formed by melting the phase change material, and immediately after the melting, quenching the phase change material. To achieve this, laser light like a relatively short, high-power pulse needs to be focused on the phase change recording layer to increase the local temperature of the phase change material to a value exceeding the melting point T of the material to locally melt the material. Thereafter, stopping the recording pulse rapidly cools the melted local area to form a solid amorphous mark subjected to a melting-quenching process.

On the other hand, the recorded data bits are erased by recrystallizing the amorphous mark. The crystallization is now achieved by local annealing. Laser light is focused on the recording layer to control the light intensity to a level slightly lower than the recording power to increase the local temperature of the phase change recording layer to a value equal to or higher than a crystallization temperature Tg while keeping the temperature lower than the melting point Tm.

At this time, by keeping the local temperature between the crystallization temperature Tg and the melting point Tm for a given time, the phase of the amorphous mark can be changed into the crystallized state. The recording mark can thus be erased.

In this case, the time after the crystallization temperature Tg is reached and before the melting point Tm is reached, which time is required for the crystallization, is called crystallization time. To reproduce the recorded data bits, the information recording layer is irradiated with DC laser light with power low enough to avoid changing the phase of the recording layer, that is, reproduction power.

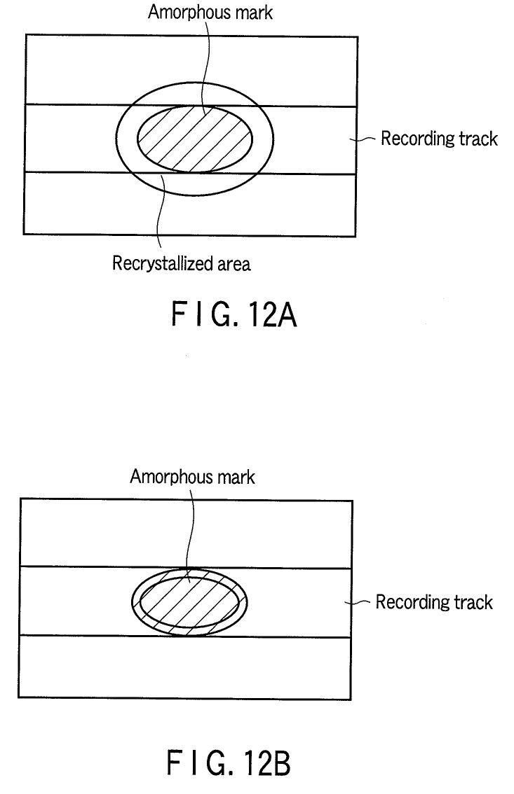

The optical recording apparatus according to the present embodiment is characterized in that a short pulse such as a relaxation oscillation pulse is used as a recording pulse for data bits. When the amorphous mark is formed by subjecting the phase change material to the melting-quenching process using the conventional recording pulse as described above, an annular recrystallized area (recrystallization ring) is formed in the peripheral part of the amorphous mark as shown in FIG. 12A.

The crystallization occurs because the corresponding area in the peripheral part of the amorphous mark is melted, and then during the cooling process, remains in the temperature region between the crystallization temperature Tg and the melting point Tm for a time equal to or longer than the crystallization time. This is effective for reducing the size of the amorphous mark (self-sharpening effect) but may cause a jitter (fluctuation) in a reproduction signal from the peripheral part of the mark, the thermal interference of a mark on a certain track with a mark on the preceding or succeeding track, or the partial erasure of the mark formed on the adjacent track (cross erase).

On the other hand, as shown in FIG. 12B, no recrystallization ring is not formed in the peripheral part of an amorphous mark formed by irradiating the recording layer made up of the eutectic phase change material according to the present invention with a short pulse such as the relaxation oscillation pulse in the optical recording apparatus according to the present embodiment. This is because the short pulse is used to irradiate the recording layer with laser light with high in a short time to melt the phase change layer immediately after the irradiation with laser light and the irradiation is stopped before the melted area spreads significantly to the peripheral part owing to heat conduction to form only the area melted immediately after the laser light irradiation into the amorphous mark. Since the eutectic material is inherently crystallized at high speed, the conventional recording method forms a large recrystallization ring in the peripheral part of the amorphous mark. However, recording with the short pulse according to the present embodiment enables formation of an amorphous mark free from the recrystallization ring.

As described above, the amorphous mark formed by the short pulse and involving no recrystallization ring has the advantages of reducing a possible jitter in the peripheral part of the mark and preventing mark deformation and edge shift caused by the thermal interference of the mark on the certain track with the mark on the preceding or succeeding track, as well as the possible cross erase of the mark formed on the adjacent track.

Of course, the recording with the short pulse has the advantages of improving the recording mark as described above and being suitable for recording at a high transfer rate because of the reduced time required to record the mark.

For optical discs, there has been a strong demand for an increased capacity and an increased transfer rate. Even for HD DVD-R and HD DVD-RW, a standard for a speed twice faster than the current standard (linear speed: 6.61 m/s) has already been issued. Further multiplied speeds such as a speed that is four or eight times faster than the standard have been expected.

To achieve the high transfer rate, the recording mark needs to be recorded at high speed, that is, in a short time. For the phase changing disc, this means that the amorphous mark is printed by the short pulse. For example, for HD DVD, a speed eight times faster than the standard corresponds to a channel clock rate of 518.4 Mbps. The time corresponding to 1 channel bit corresponds to 1.929 ns.

The pulse width required for the short pulse recording in the optical recording apparatus according to the present embodiment is such that no recrystallization ring is generated during the formation of the amorphous mark. The area formed into the recrystallization ring during the formation of the amorphous mark is melted once, that is, the temperature of the area exceeds the melting point of the phase change material. In this case, only a part of the area the temperature of which slightly exceeds the melting point is recrystallized.

This is because a part of the area the temperature of which increases significantly above the melting point has a large temperature decrease gradient and is relatively rapidly cooled and thus made amorphous. This is in turn because as is apparent from the well-known relationship between a temperature gradient δT/δx and the density of heat flow rate q(W/m²) (Fourier's heat conduction rule), q=K·δT/δx, the rate of heat flow from a hot area to a cool area increases consistently with temperature gradient. Here, K(W/m·K) denotes heat conductivity, and x denotes a distance at an interface with a temperature difference in the direction of the heat conduction (the direction of a normal vector at the interface).

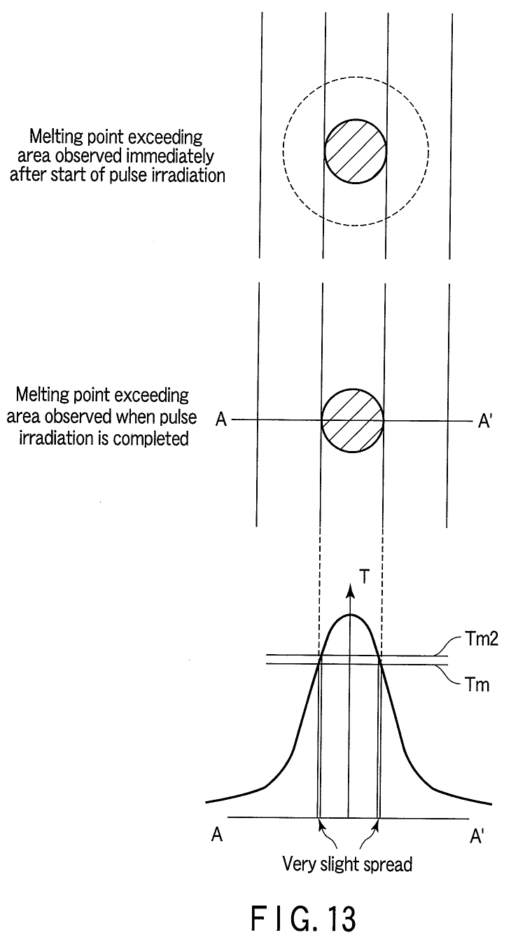

For the short pulse recording, high power laser light is applied such that immediately after the laser light irradiation, the temperature of the central part of the light spot exceeds the melting point. FIG. 13 is a diagram illustrating the temperature distribution on a recording track. An upper stage in FIG. 13 shows a melting point exceeding area on the track observed immediately after the recording pulse irradiation. A middle stage in FIG. 13 shows the melting point exceeding area observed when the recording pulse is completed. A lower stage in FIG. 13 shows the distribution of temperature in a cross section taken along line A-A′ in the middle stage.

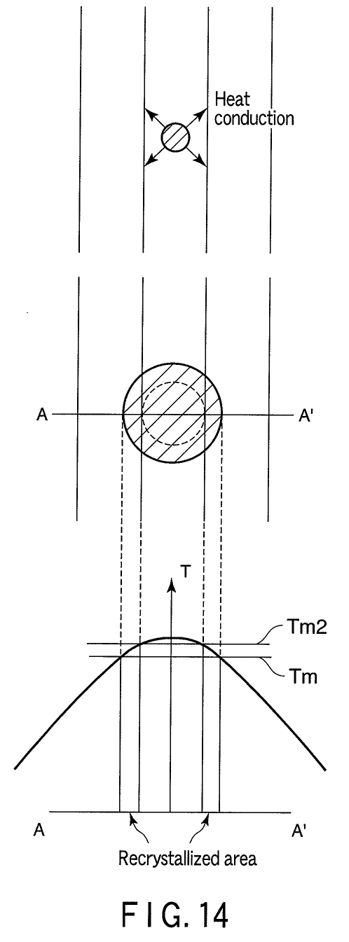

FIG. 13 illustrates the case of the short pulse recording, and FIG. 14 illustrates the case of the recording with the conventional recording pulse. A recording beam spot (a dashed area in FIG. 13) inherently moves in the vertical direction of the figure. However, in this example, for simplification, the recording beam spot is assumed not to move.

With any recording pulse, owing to heat conduction, the central area of the spot with the temperature exceeding the melting point starts to spread immediately after the pulse irradiation and continues to spread until the completion of the pulse. However, with the short pulse, the central area does not substantially spread owing to the short pulse irradiation time.

With the short pulse recording, the temperature distribution in the cross section including the center of the light spot observed at the time of the completion of the pulse is shaped like a Gaussian distribution that is almost the same as that observed immediately after the light beam irradiation. Thus, the temperature gradient is steep in an area with the temperature equal to or higher than the melting point and an area with the temperature equal to or lower than the melting point, which areas are located close to the boundary corresponding to the melting point. Thus, the recrystallized area, that is, the area with the temperature slightly exceeding the melting point (the area with the temperature between the melting point Tm and temperature Tm2 in FIG. 13), has almost no spread in a planar direction. Therefore, if the time is so short that the spread of the central area of the light spot with the temperature equal to or higher than the melting point, which spread results from heat conduction, is negligible and the laser power is zero, then the recrystallization ring is limited to a very narrow area.

On the other hand, to form the mark with the conventional recording pulse, relatively low power is applied for a long time. Thus, the central area of the light spot with the temperature exceeding the melting point spreads gradually (from the upper stage to the middle stage in FIG. 14). At this,time, the temperature distribution in the cross section including the center of the light spot is no longer a Gaussian distribution but is shaped to have a gentler temperature gradient (the lower stage in FIG. 14).

Thus, the recrystallized area has a relatively large spread in the planar direction. A dashed line in the middle stage in FIG. 7B shows the limit of recrystallization. The area enclosed by the dashed line corresponds to the amorphous mark. Thus, the conventional recording pulse results in the large recrystallization ring during the mark formation.

The width of the recrystallization ring in the planar direction is expected to be almost similar to the distance over which the melting point area spreads in the planar direction during the pulse irradiation time. For a common phase change material, when the heat conductivity K=0.005 J/cm/s/° C. and specific heat C=1.5 J/cm³/° C., the thermal diffusion distance during the pulse irradiation time can be estimated. Since heat is expected to diffuse by the distance L=(Kt/C)½ during the time t, the area of the recrystallization ring is limited to at most 10% of the minimum mark length of 0.204 μm for HD DVD-RW. That is, to limit the distance to 10.2 nm or shorter in one direction, the pulse irradiation time needs to be set to 0.44 ns. This corresponds to the pulse width required for the short pulse recording.

As already described, Formula (2) is given as the relationship between the resonator length of the semiconductor laser and the relaxation oscillation pulse width Wr obtained. This indicates that a pulse width of at most 440 ps, that is, a semiconductor laser of resonator length at most 3,520 μm, needs to be used for the short pulse recording.

On the other hand, for a reduction in the size of the recrystallization ring, better results are obtained with a shorter pulse irradiation time. However, in a practical sense, it is difficult to apply energy required to increase the temperature of the phase change material to the melting point or higher. That is, very high energy needs to be applied in a short time. Thus, in a practice sense, the pulse irradiation time needs to be at least about 50 ps. In connection with the relationship in Formula (2), this corresponds to the need of a semiconductor laser of resonator length at least 400 μm.

As is apparent from Formula (2), when the relaxation oscillation pulse is used to record information on the optical disc 1, the relaxation oscillation pulse width is uniquely determined by determining the resonator length of the semiconductor laser 20 for the optical recording apparatus. As described above, with a short pulse width, high power is applied to increase the temperature of the phase change material to the melting point or higher. However, the temperature of the phase change material may fail to reach the melting point or higher even when the material is irradiated with the maximum power from the semiconductor laser 20. In such a case, the relaxation oscillation pulse can be usefully applied a number of times.

FIG. 15 shows an optical pulse waveform obtained when the drive pulse for the semiconductor laser 20 is controlled so as to generate the relaxation oscillation pulse three times. The relaxation oscillation pulse is generated three times to increase the irradiation energy (the time integration value for the pulse in FIG. 15) provided by the pulse. This enables the temperature of the phase change material to be increased to the melting point or higher. However, as shown in the figure, the intensity of the second and third pulses decreases gradually compared to that of the first pulse. Thus, further plural pulse irradiations are not so effective.

Thus, for the optical recording apparatus recording data on the optical recording medium using the relaxation oscillation pulse from the semiconductor laser 20, the number of relaxation oscillation pulses needs to be increased or reduced depending on the resonator length of the laser. Furthermore, even if a semiconductor laser with low rated power is used, a plurality of relaxation oscillation pulses can be effectively used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, in the above-described example, the rewritable optical disc using the phase change material is used. However, the present invention is applicable to, for example, a write-once (recordable) optical disc.

The above-described embodiment provides a high-density, large-capacity information recording medium which prevents possible cross erase and on which information can be reliably recorded.

TABLE 1

| | |
|---|---|
| Light source wavelength (nm) | 405 |
| Objective lens NA | 0.65 |
| Linear speed (m/s) | 10.0 |
| Minimum pit length (μm) | 0.177 |
| Threshold current (mA) | 36 |
| Recording current (mA) | 110 |
| Bias current (mA) | 45 |
| Reproduction current (mA) | 40 |

TABLE 2

| | Pulse width | | | | |
|---|---|---|---|---|---|
| nT | (ns) | WR (μm) | WA (μm) | WR/WA | WA/TP |
| 2T | 0.1 | 0.181 | 0.181 | 1.00 | 0.60 |
| | 0.15 | 0.226 | 0.222 | 1.02 | 0.74 |
| | 0.25 | 0.235 | 0.230 | 1.02 | 0.77 |
| | 0.5 | 0.276 | 0.267 | 1.03 | 0.95 |
| | 1.5 | 0.343 | 0.275 | 1.25 | 0.92 |
| 11T | 0.1 | 0.187 | 0.187 | 1.00 | 0.62 |
| | 0.15 | 0.237 | 0.232 | 1.02 | 0.77 |
| | 0.25 | 0.259 | 0.254 | 1.02 | 0.85 |
| | 0.5 | 0.294 | 0.288 | 1.02 | 0.96 |
| | 1.5 | 0.349 | 0.272 | 1.28 | 0.91 |

What is claimed is:

1. An information recording medium comprising a phase change material in which information is recorded on, reproduced from, and erased from a recording layer of the medium by light irradiation,
wherein a recrystallization width (WR) at a periphery of an amorphous recording mark formed on the recording layer by light irradiation, and a recording mark width (WA) and a track pitch (TP) satisfy 1.0<WR/WA<1.1 and 2/3<WA/TP<4/3.

2. The medium of claim 1, wherein the recording layer on which information is recorded comprises a material obtained by combining Sb with at least one selected from the group consisting of Te, Ge, Bi, Sn, Ga, and In.

3. The medium of claim 1, wherein the recording mark is formed by irradiation with a pulse width substantially between 200 ps and 1 ns from a semiconductor laser during information recording.

4. The medium of claim 2, wherein the recording mark is formed by irradiation with a pulse width substantially between 200 ps and 1 ns from a semiconductor laser during information recording.

5. An information recording method for an information recording medium comprising a phase change material in which information is recorded on, reproduced from, and erased from a recording layer of the medium by light irradiation, comprising:
recording information on the recording layer with a light of a pulse width between 200 ps and 1 ns by a semiconductor laser.

6. The method of claim 5, wherein the recording layer on which information is recorded comprises a material obtained by combining Sb with at least one selected from the group consisting of Te, Ge, Bi, Sn, Ga, and In in the phase change material.

7. An information recording and reproducing apparatus for an information recording medium comprising a phase change material in which information is recorded on, reproduced from, and erased from a recording layer of the medium by light irradiation, the apparatus comprising a controller configured to control a semiconductor laser in order to record information on the recording layer, to reproduce the information from the recording layer and to erase the information from the recording layer, the recording layer is irradiated with a pulse width substantially between 200 ps and 1 ns.

8. The apparatus of claim 7, wherein a recrystallization width (WR) at a periphery of an amorphous recording mark formed on the recording layer by irradiation from the semiconductor laser, and a recording mark width (WA) and a track pitch (TP) satisfy 1.0<WR/WA<1.1 and 2/3<WA/TP<4/3.

9. The apparatus of claim 7, wherein the recording layer on which information is recorded comprises a material obtained by combining Sb with at least one selected from the group consisting of Te, Ge, Bi, Sn, Ga, and In in the phase change material.
